(19) United States
(12) Patent Application Publication
(10) Pub. No.: US 2006/0046716 A1
(43) Pub. Date: Mar. 2, 2006

(54) Multi-network seamless roaming through a software-defined-radio

(75) Inventors: Christian E. Hofstaedter, Hellertown, PA (US); Randy H. Ellison, Fogelsville, PA (US); Shane L. Baker, Easton, PA (US); Christopher J. Bogdon, Cranberry Township, PA (US)

Correspondence Address: GREENBLUM & BERNSTEIN, P.L.C., 1950 ROLAND CLARKE PLACE, RESTON, VA, 20191, US

(73) Assignee: PADCOM, Inc., Bethlehem, PA (US)

(21) Appl. No.: 11/209,657

(22) Filed: Aug. 24, 2005

Related U.S. Application Data
(60) Provisional application No. 60/604,045, filed on Aug. 25, 2004.

(51) Int. Cl. H04Q 7/20

(52) U.S. Cl. 455/432.2

(57) ABSTRACT

A method is provided for seamless roaming over multiple dissimilar wireless networks leveraging a set of one or more SDRs, and possibly some traditional radio communication devices. The method includes determining whether alternate networks are available regardless of whether the SDR has only a single transmitter and receiver or multiple transmitters and receivers. In addition, if the SDR provides multiple transmitters and receivers, or if multiple distinct SDRs are available to the mobile computing device, the method will be able to better optimize the seamless roaming experience for the user while still utilizing the set of SDRs, in part, to determine whether alternate networks are available. The method further includes managing the transitions of an SDR between various modulation algorithms according to a variety of states and settings of the SDR or of the set of SDRs as a whole.

### CROSS REFERENCE TO RELATED APPLICATIONS

The present application claims the benefit of U.S. Provisional Patent Application No. 60/604,045 in the names of C. BOGDON et al. filed on Aug. 25, 2004, the disclosure of which is expressly incorporated by reference herein in its entirety.

The present application is related to U.S. patent application Ser. No. 10/084,049, filed on Feb. 28, 2002, entitled “Port Routing Functionality,” which is a continuation-in-part of U.S. patent application Ser. No. 09/652,009, filed on Aug. 31, 2000, entitled “Method and Apparatus for Routing Data Over Multiple Wireless Networks”, and also a continuation-in-part of U.S. patent application Ser. No. 08/932,532, filed on Sep. 17, 1997, now U.S. Pat. No. 6,418,324, entitled “Apparatus and Method for Intelligent Routing of Data between a Remote Device and a Host System,” which is a continuation-in-part of U.S. patent application Ser. No. 08/456,860, now U.S. Pat. No. 5,717,737, entitled “Apparatus and Method for Transparent Wireless Communication Between a Remote Device and a Host System,” the contents of which are expressly incorporated by reference herein in their entireties.

The present application is also related to U.S. patent application Ser. No. 10/374,070, entitled “Prioritized Alternate Port Routing,” filed on Feb. 27, 2003, which published as U.S. Patent Application Publication No. 2004/0170181 A1, the content of which is expressly incorporated by reference herein in its entirety.

The present application is also related to U.S. patent application Ser. No. 10/835,396, entitled “Simultaneously Routing Data Over Multiple Wireless Networks,” filed on Apr. 30, 2004, the content of which is expressly incorporated by reference herein in its entirety.

### BACKGROUND OF THE INVENTION

1. Field of the Invention

The present invention relates to the field of wireless communications. More particularly, the present invention relates to communicating over multiple dissimilar wireless networks when using Software Defined Radios (SDRs), a combination of several SDRs, or a set of radios some of which are SDRs and some of which are traditional radios. An aspect of the present invention allows a mobile computing device to send and/or receive data over multiple dissimilar wireless networks as mobile users seamlessly roam between them using a set of radios comprised partially or fully of SDRs.

2. Background Information

Within the last decade, wireless networks have become integral to the day-to-day activities of mobile workers. Many organizations continue to realize substantial cost savings through the use of wireless networks to increase worker productivity. In many cases, wireless networks have also resulted in the creation of new services that companies have been able to provide to their customers.

Wireless carriers have spent billions of dollars in building out new 3^{rd} generation networks like GPRS, EDGE, 1xRTT, and 1xEvDO. 802.11 Wireless LANs are being proliferated around the world. Finally, many private RF networks like RD-LAP, EDACS, Opensky, Dataradio, and conventional or trunked networks exist which are being used by millions of utility and public safety workers throughout the world.

There are existing patents like U.S. Pat. No. 6,198,920, to DOVIAK et al., entitled “Intelligent Routing of Data between a Remote Device and a Host System” and U.S. Pat. No. 6,418,324, to DOVIAK et al., entitled “Apparatus and Method for Transparent Wireless Communication between a Remote Device and a Host System”, the contents of which are expressly incorporated by reference herein in their entireties, that claim improved simultaneous utilization of multiple networks. In these patents, users can seamlessly roam between dissimilar networks. Therefore, as a mobile worker goes out of range of a primary network, the worker can continue to communicate over an alternate network.

Solutions created for seamless roaming between dissimilar networks have helped to promote the adoption of wireless networks. They allow mobile workers to better take advantage of the varying strengths of the different networks and to minimize any limitations that they may exhibit. As an example, since wireless LANs provide high bandwidth access over a narrow area and CDMA 1xRTT provides lower bandwidth over a wide area, mobile clients can be configured to automatically use both networks. When in range of the Wireless LAN (whether they are also in range of CDMA 1xRTT or not), they will take advantage of the increased throughput of that network. But when they roam out of the limited coverage area of Wireless LAN and remain, or enter into, the coverage area of the CDMA 1xRTT network they will automatically take advantage of that network and its larger coverage area.

While these types of solutions are very powerful for end-users and they provide improved control over the wireless networks, several challenges remain with seamless roaming solutions. Traditionally, when users need to roam between the different networks, they must acquire one wireless transceiver for each network. In this model, each wireless transceiver is specifically associated with the one network, and only the one network, for which it was acquired. Therefore, mobile computing devices that are operating a seamless roaming solution typically have multiple communication devices that are used for communication over the multiple networks. Not only do these multiple communication devices typically represent a significant capital expense, but maintaining multiple communication devices in an active state also consumes precious battery life. Multiple distinct communication devices may also require use of excessive physical resources within the mobile computing device such as PC Card and serial port interfaces. Further, when new network services are introduced, legacy communication devices would, most likely, not be capable of communicating over the new network. In this case, the users are forced to incur additional capital expenses if they want to take advantage of the new services.

Much research and development effort has been applied to the creation of solutions to these problems. One such solution is the Software Defined Radio (SDR). An SDR will help solve many of the issues that are associated with wireless data usage. The SDR provides a capability where radio characteristics are modified through software to adapt the radio to a variety of different wireless networks. Therefore, with minimal impact, SDRs provide capabilities which allow mobile devices to communicate over any wireless network for which a suitable software algorithm exists that can be downloaded to the SDR. All that is required is to update the SDR with new software algorithms to adapt the radio to the new wireless network.

When combining the concept of SDRs with seamless roaming between dissimilar networks, a mobile user can realize a vastly increased set of possibilities with regard to network connectivity and automatic network connections. Now a mobile device can use a single hardware platform that can support virtually any wireless network. However, existing SDR solutions are burdened with several issues that could hinder their adoption by the wireless data market.

Traditionally, much of the reprogramming of SDRs only occurs through manual intervention by the user of the mobile device. Therefore, not only is the user encumbered by the requirement to automatically make the determination of which network should be used, but they are also responsible for manually initiating the commands to reprogram the SDR with the necessary software to support transmission through the new medium.

Another issue with traditional SDRs is the lack of any inherent capability to actively probe for the characteristics of an alternate network that is different from the currently active network. By way of non-limiting example, such network characteristics may include signal strength and/or latency. If the network that is presently programmed into an SDR is being actively used for transmission or reception of data, it is problematic to change the software algorithm of the SDR, check the status of the new network, and then go back to the original network to continue the communications. A scenario such as this can easily lead to lost data, application failures, or dropped TCP sessions. Additionally, if the user is directly responsible for this type of usage model, the amount of manual intervention may be too burdensome to permit widespread adoption.

Therefore, a need exists to manage communications over multiple wireless networks when using an SDR. Also, a need exists for a system that dynamically reconfigures an SDR to support the dynamic nature of mobile users. Moreover, a need exists for a system to intelligently probe for the availability of other wireless networks without severely impacting the applications. Finally, there exists a need to automatically manage this capability without any user intervention.

SDRs are systems of transmission that leverage software for the modulation and demodulation of the radio signal. Traditionally, radios were developed toward a specific frequency, transmission medium, and protocol and the capabilities were immutably designed into the device. This architecture made it very time consuming and costly to modify or reprogram the radio to support a new format or network. Therefore, mobile users were forced into purchasing new hardware when their wireless networking needs changed.

SDRs are designed to solve the “Upgrade Problem” that exists with traditional wireless communication devices. Instead of providing the wireless network information in hardware, the system is built upon a flexible platform. Support for different wireless networks is written in modulation algorithms using various programming languages. Modulation algorithms describe the characteristics of the network and the method of communication through the network. Therefore, for a mobile user to communicate across a wireless network all that they are required to do is to load the appropriate modulation algorithm into the hardware platform of the SDR. All this capability is provided through software modifications so upgrades or changes can occur with less effort and less cost that was previously possible.

Many SDRs are equipped with only a single RF transmitter/receiver. An exemplary architecture is shown in FIG. 1. The SDR 100 contains several pieces of hardware or software components. It provides an RF-Digital Converter 101 to provide the conversion layer between the digital signal processing and the RF network. The FPGA and DSP 102 are providing the capabilities of processing the modulation algorithms. The modulation algorithms are downloaded to the SDR 100. Exemplary modulation algorithms include GSM 104, CDMA 105 and WiMax 106. Finally a microcontroller 103 provides the underlying support structure to control the entire SDR 100.

In addition to the SDR 100, a mobile computing device 108 is used. The mobile computing device will be responsible for executing applications and code modules that create data packets. These data packets are sent across a physical data link 107. By way of non-limiting example, the physical data link may take the form of RS-232, Ethernet, USB, UWB, Bluetooth, or other standard links. Within the mobile device 108 there also exists an operating system 110. The operating system runs the SDR Software Controller 109 that will control the SDR capability. The operating system 110 also runs the applications that generate the data packets and the operating system 110 may actually generate data packets itself. The operating system 110 also supports the roaming solution that manages the roaming between multiple dissimilar networks. The roaming solution may be embodied as an integrated component of the operating system 110 or as application software running on top of the operating system 110.

With this type of design, the radio would have only a single personality at a time. Therefore, to change modes, the user would be required to download the new modulation algorithms in order to use a new network. Once the user performed this action, the user would be further required to download the original modulation algorithms if they desired to transition back to the original network.

One characteristic of seamless roaming solutions is the ability to automatically probe for the availability of other wireless networks so that they may understand when it is the best time to switch the active network. If only a single transmitter/receiver exists, the radio can be configured to support only one network at any one time. Therefore, a need exists to automatically reconfigure the radio periodically so that the middleware can check for alternate wireless networks. This function has to be transparent to the end user.

One method that can solve this issue is to define an SDR 100 with multiple RF transmitters/receivers. FIG. 2 shows an example of a system that supports this type of architecture. This architecture builds off the initial SDR architecture and provides a secondary FPGA and DSP 102 and a secondary RF-Digital Converter 101. A system created with this design allows middleware software to use one transmitter/receiver for primary transmission while using a secondary transmitter/receiver to query the availability of a series of alternate networks that could be used for communication should the primary network become unusable. While this process is more efficient (i.e., the primary channel is not disrupted as other networks are being scanned), the user of the mobile computing device has traditionally been required to manually intervene in order to change the profile on the secondary channel to determine the viability of an alternate network. Middleware solutions should be developed to automatically perform the configuration and query functions to make this process as transparent as possible. It should be noted that if an SDR 100 does not support multiple RF transmitters/receivers, then multiple SDR units 100 each with a single RF transmitter/receiver may provide identical capabilities. For the purposes of the present invention, both configurations are considered interchangeable.

Although SDRs are emerging as the default standard for wireless communications, there will be situations where SDRs 100 will be useful for some networks while non SDR modem implementations would be useful for other networks. For example, in a high speed link, the physical resource requirements for executing the high speed modulation algorithms may be more expensive than desired. Therefore, there may be situations where an SDR 100 will be combined with a traditional (non-SDR) implementation. This architecture is described in FIG. 3 and builds from the architecture presented by FIG. 2. This architecture supports a traditional RF Radio 112 that is connected to the mobile device 108. This radio 112 can be either embedded within the mobile device 108 or connected externally. Therefore, the middleware software would be able to view all personalities on the SDR 100 as individual networks and automatically combine those with the different traditional modems 112 outfitted within the mobile computer 108 as well.

Additionally, due to the flexibility enabled by the SDR design, modulation algorithm designers can offer additional differentiating features that can leverage and extend SDR capabilities. Middleware software applications that control the SDR 100 can also be used to help modify parameters dynamically within the modulation algorithms. One use of this would be for extra security on the transmissions. For example, if a middleware application can dynamically alter portions of the modulation algorithm through Application Programmers Interfaces (APIs), the middleware application would be able to change the modulation algorithm just slightly so that eavesdroppers would be unable to decode any of the transmissions. This capability actually requires several pieces of synchronization that must occur between the clients and the base stations to ensure that all mobile units are speaking in the same format.

### SUMMARY OF THE INVENTION

In view of the foregoing, an aspect of the present invention is directed to using one or more SDRs in combination with zero or more traditional radios for either simultaneous communication or seamless roaming capabilities while maintaining a static mobile host identity and while roaming across multiple dissimilar networks, some of which are supported through distinct modulation algorithm programs on the same physical SDR.

According to an aspect of the invention, a capability is provided for mobile users to leverage SDRs for seamlessly roaming communications across multiple dissimilar networks. The process is meant to be seamless and transparent to the mobile user and the application. Some of the functions described below traditionally are done manually. However, for truly pervasive seamless roaming to be a reality, these capabilities must be handled automatically by the wireless middleware solution.

According to an aspect of the present invention, a method is provided for managing the transitions of an SDR between various modulation algorithms. The method includes coordinating the transitions such that modulation algorithm selections are made according to user preferences. The method also includes coordinating the transitions such that modulation algorithm selections can be made dynamically through an application-programming interface. The method also includes coordinating the transitions such that they occur only during periods in which they will have the least impact on seamless communication from the mobile computing device. The method also includes coordinating the transitions such that they occur during periods of high likelihood of encountering a more desirable network.

According to an aspect of the present invention, a method is provided to modify the transition management behavior described above solely on the basis of an associated database of scanning hints rather than on a pre-configured interval. The scanning hints can be based upon geographic position, time of day, or a variety of other external indications. By way of non-limiting example, additional external indications may include battery power of the mobile device or network signal strength trends over time.

According to an aspect of the present invention, a method is provided to modify the transition management behavior described above due to the presence of specific types of traffic. By way of non-limiting example, the criteria used to identify specific types of traffic may be similar to that used in U.S. Patent Application Publication No. 2004/0170181 A1, entitled “Prioritized Alternate Port Routing” (mentioned above) the content of which is expressly incorporated by reference herein in its entirety.

According to another aspect of the present invention, a method is provided for managing the transition management behavior described above to ensure that, in the event that multiple SDRs are present on the mobile computing device, the multiplicity of SDRs may be maintained simultaneously in an active state. The method also includes managing the set of multiple simultaneously active SDRs such that seamless roaming switch time can occur rapidly when the network from which the transition is taking place is no longer available to the mobile computing device. The method also includes coordinating the transitions across a set of multiple physical SDR devices such that no two or more physical SDR devices scan and lock onto the same modulation algorithm. The method also includes managing the packet flow across the set of multiple simultaneously active SDRs in the same manner as described in U.S. patent application Ser. No. 10/835,396, “Simultaneously Routing Data Over Multiple Wireless Networks” (mentioned above) the content of which is expressly incorporated by reference herein in its entirety.

According to an aspect of the present invention, a method is provided to minimize any packet loss during the transition periods in which alternate networks are measured for viability. The method includes a messaging protocol to ensure that all packets are transmitted over an alternate network during the period in which alternate modulation algorithms are tested in the SDR.

According to an aspect of the present invention, a method is provided to verify the viability of the network connectivity corresponding to the modulation algorithm that is being tested. The method includes a protocol between novel components and the operating system for the purpose of determining network connectivity. The method includes a protocol between novel components and the SDR for the purpose of determining the network connectivity. The method includes the use of middleware services such as those described in existing patents like U.S. Pat. No. 6,198,920, entitled “Intelligent Routing of Data between a Remote Device and a Host System” and U.S. Pat. No. 6,418,324, “Apparatus and Method for Transparent Wireless Communication between a Remote Device and a Host System” (both mentioned above) for determining network connectivity. The method also includes the use of gateway-based beacons from solutions such as the patents described above for determining network connectivity. The method also includes the use of loopback or “ping” packets for determining network connectivity. The method also includes the use of common Internet Protocol protocols and services for determining network connectivity. By way of non-limiting example, common Internet Protocol protocols and services may include such services as Requirements for Internet Hosts—Communication Layers (as described in RFC 1122), Router Advertisements (as described in RFC 1256), DHCP (as described in RFC 2131 and 3315), and Mobile IP (as described in RFC 2002) the contents of which are expressly incorporated by reference herein in their entireties.

According to still another aspect of the present inventions, a method is provided to manage the configuration database of transition management behavior from a centrally controlled gateway such that the appropriate configuration settings are downloaded and made available to the mobile computing device whenever the solution is initialized and whenever the centrally managed configuration database is updated in such a way as to be applicable to the mobile computing device.

According to another aspect, a method is provided for seamlessly roaming across multiple dissimilar wireless networks using at least one software defined radio (SDR). The SDR(s) include modulation algorithms, each algorithm enabling access to at least one of the dissimilar networks. The method includes seamlessly roaming across the dissimilar wireless networks while only using a single transceiver of SDR(s). The method also includes prioritizing the modulation algorithms.

The method may include scanning for a limited time an alternate network of the wireless networks, when a primary network is designated as in-use. In one embodiment, the method includes scanning the dissimilar networks to check a network quality. In yet another embodiment, the method also includes scanning the dissimilar networks. The scanning can include downloading a modulation algorithm to the SDR(s), initializing the SDR(s) and checking whether a network associated with the downloaded algorithm is in coverage.

The method may further include updating the prioritization of modulation algorithms in response to hint criteria being satisfied. The hint criteria may designate a time and/or a location.

In a still further aspect, a system is provided for seamlessly roaming across dissimilar wireless networks using at least one software defined radio (SDR). The SDR(s) include modulation algorithms, each algorithm enabling access to at least one of the dissimilar networks. The system includes a network management subsystem and a configuration subsystem. The network management subsystem processes packets to be sent to a network accessible through a selected modulation algorithm of the SDR(s), and scans through modulation algorithms on the SDR device(s). The configuration subsystem communicates with the network management subsystem to provide configuration information.

The system can also include an application programming interface (API) subsystem that receives network status notifications from the network management subsystem and publishes the status notifications for external entities. The API subsystem can receive instructions from an external entity to designate at least one of the dissimilar networks as currently most preferred. The API subsystem can receive instructions from an external entity to transmit a packet through a specific one of the dissimilar wireless networks.

The network management subsystem can further check network quality of the networks accessible through selected modulation algorithms.

The configuration subsystem can communicate with a centralized software controller to obtain configuration updates.

The system can also include a routing support subsystem that aborts scans to minimize packet loss.

In yet another aspect, a computer readable medium stores a program for seamlessly roaming across dissimilar wireless networks using at least one software defined radio (SDR). The SDR(s) include modulation algorithms, each algorithm enabling access to at least one of the dissimilar networks. The medium includes a roaming code segment that enables seamless roaming across the dissimilar wireless networks while only using a single transceiver of the SDR(s); and a priority code segment that prioritizes the modulation algorithms. Each modulation algorithm can be a GPS algorithm or a bi-directional data network modulation algorithm. The roaming code segment can also enable simultaneous use of multiple networks.

The medium can include a scanning code segment that scans for a limited time an alternate network, when a primary network is designated as in-use.

The medium can include a hint code segment that updates the modulation algorithm priorities in response to hint criteria being satisfied.

The medium can include a scanning code segment that scans the dissimilar networks to check a quality of the networks. Alternatively, or in addition, the scanning code segment scans the dissimilar networks by downloading a modulation algorithm to the SDR(s), initializing the SDR(s), and checking whether a network associated with the downloaded algorithm is in coverage.

The medium may further include a pruning code segment that ensures that each connected modulation algorithm is used by only a single SDR and/or a receiving code segment that receives hint updates from an external entity.

The medium can have a scan frequency code segment that dynamically changes a scan frequency based upon a state of the SDR(s).

The medium can include a coverage checking frequency code segment that changes a coverage checking frequency based upon each modulation algorithm.

The features described above may be embodied as object code recorded on a computer readable medium. The features may also be part of a process for managing the flow of packetized data across dissimilar networks. Moreover, the features may be part of a system including a SDR Software Controller component and a router.

### BRIEF DESCRIPTION OF THE DRAWINGS

The present invention is further described in the detailed description that follows, by reference to the noted drawings by way of non-limiting examples of preferred embodiments of the present invention, in which like reference numerals represent similar parts throughout several views of the drawings, and in which:

FIG. 1 illustrates a general overview of a traditional SDR with a single RF transmitter;

FIG. 2 illustrates a general overview of an SDR with multiple RF transmitters;

FIG. 3 illustrates a general overview of an SDR used in conjunction with a traditional RF radio that is physically connected to a mobile computing device;

FIG. 4 illustrates an exemplary embodiment of in-memory data structures that serve to maintain a run-time state, according to an aspect of this invention;

FIG. 5 illustrates a system architecture diagram that depicts the integration of aspects of the invention with existing systems that provide seamless roaming services across dissimilar networks;

FIG. 6 illustrates a system architecture diagram that depicts exemplary subsystems and data stores that comprise aspects of the invention;

FIG. 7 illustrates a state transition diagram for one aspect of the system;

FIG. 8 illustrates exemplary configuration data structures as a sample XML file;

FIG. 9 illustrates another set of exemplary configuration data structures as a sample XML file;

FIG. 10 illustrates an exemplary flow chart that describes a main flow of the Network Management subsystem, according to an aspect of the invention;

FIG. 11 illustrates an exemplary flow that describes a detailed flow of Scan Processing behavior, which is an aspect of the main flow described in FIG. 10; and

FIG. 12 illustrates an exemplary flow that describes calculation of a timeout period used in the scan processing main control loop of FIG. 10, according to an aspect of the invention.

### DETAILED DESCRIPTION

System Architecture:

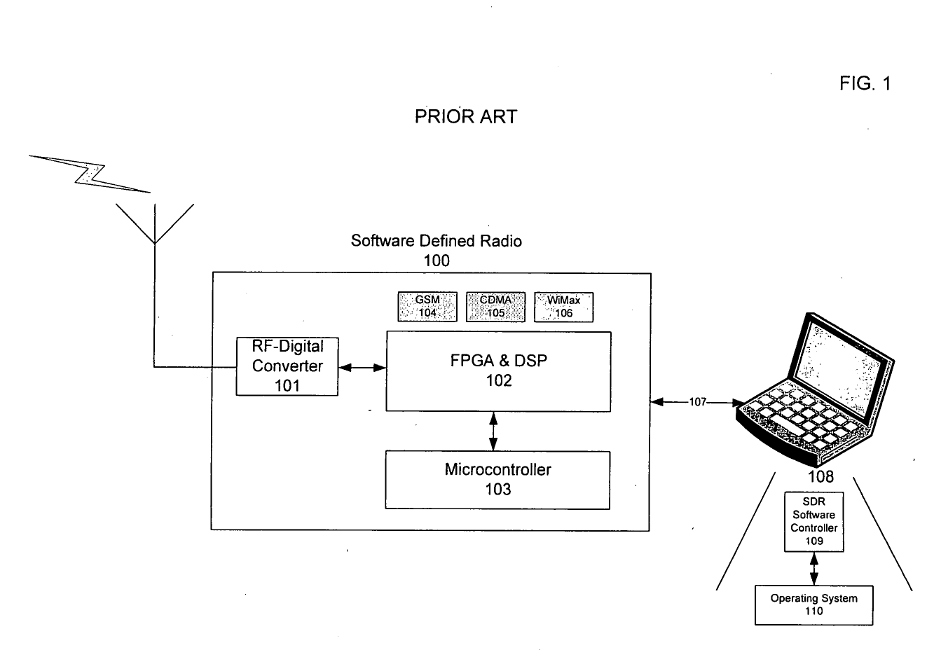

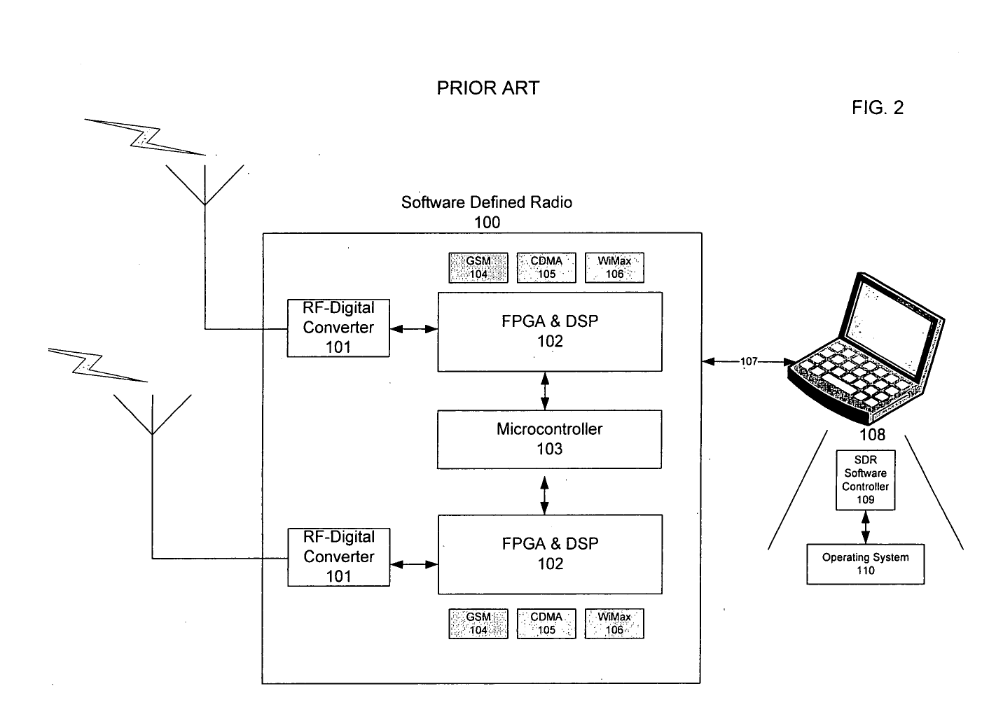

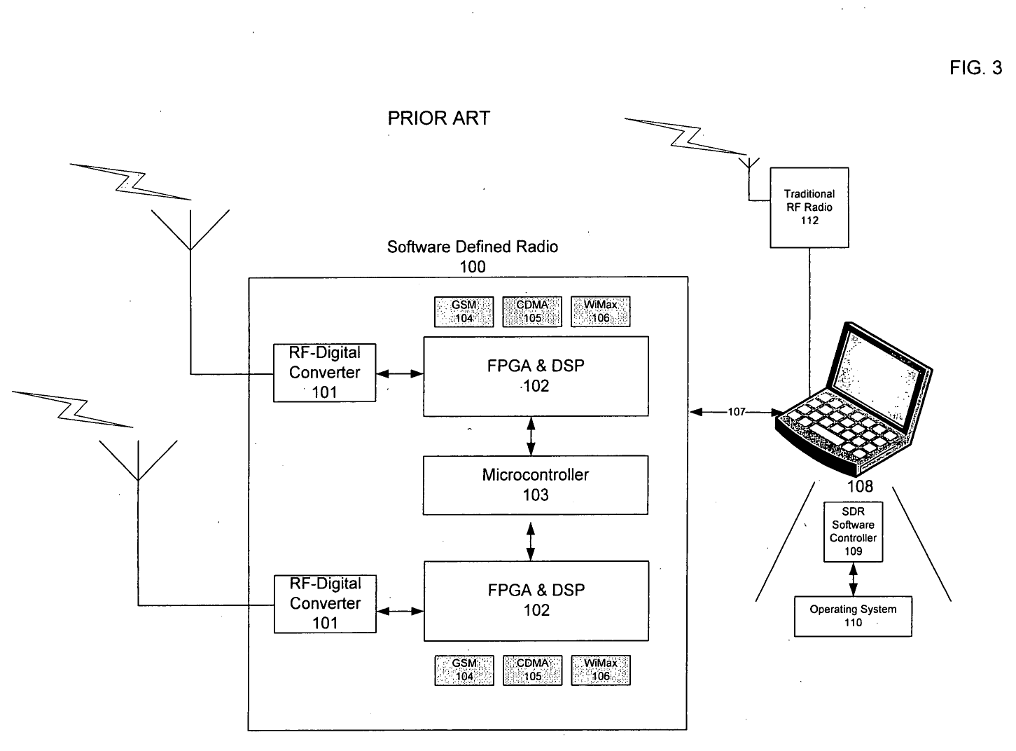

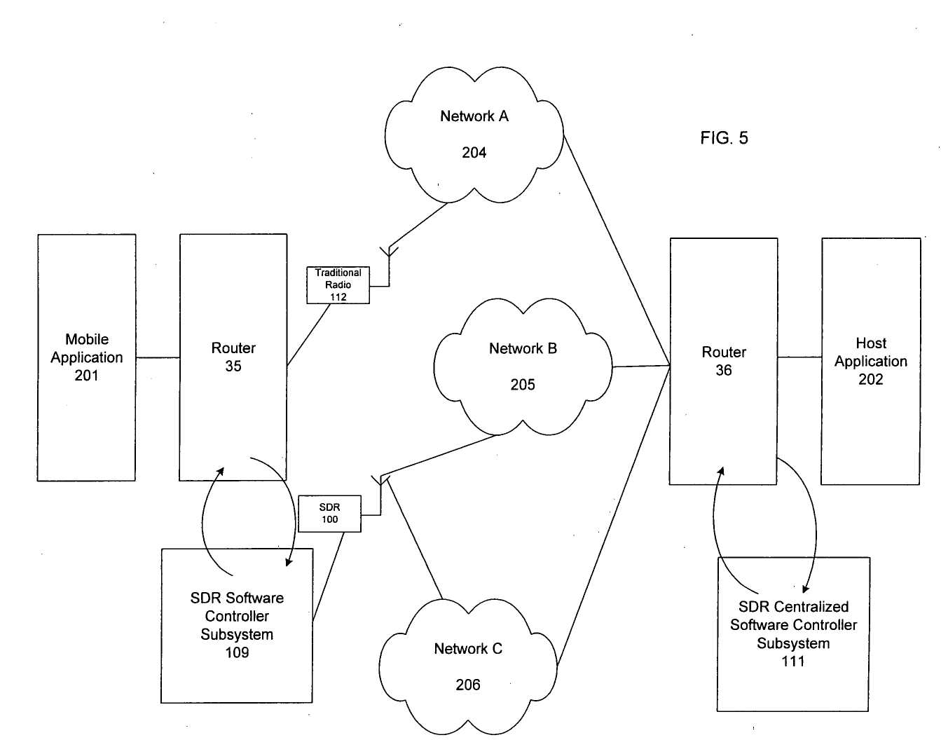

An SDR Software Controller 109 can operate in a standalone fashion as indicated in FIG. 1, FIG. 2, and FIG. 3. Nonetheless, often an SDR Software Controller 109 is used in conjunction with a wireless router. An exemplary router is described in U.S. Pat. Nos. 6,198,920 and 6,418,324 discussed above, the disclosures of which are expressly incorporated by reference herein in their entireties. FIG. 5 shows an example of communications between a router 35 and the SDR Software Controller system 109. FIG. 5 also shows an example of communications between another router 36 and an SDR Centralized Software Controller Subsystem 111. The system also includes a mobile application 201 and a host application 202. The system also includes a Traditional Radio 112 and a Software Defined Radio 100. The system also includes three dissimilar networks 204, 205, and 206.

The router 35 communicates directly to the Traditional Radio 112 for the purpose of establishing a viable communication link and sending or receiving traffic over Network A 204. The router 35 also communicates directly with the SDR Software Controller system 109 for the purpose of exchanging status regarding the state of the SDR 100 and the networks 205 and 206 that may be reached through the SDR 100. The SDR Software Controller system 109 communicates with the SDR 100 for the purpose of downloading new modulation algorithms and initializing the radio for their use, for checking connectivity for the networks 205 and 206, and for sending or receiving data packets. The router 35 communicates directly with Network A 204 through a traditional (non-SDR) radio 112. Additionally, the router 35 communicates with Network B 205 or Network C 206, through the SDR Software Controller 109, in order to send and receive data packets. The SDR Centralized Software Controller system 111 communicates with the router 36 in a proxy fashion—just like other application servers—for the purpose of exchanging information with all of the SDR Software Controller systems 109.

The Mobile Application 201 and the Host Application 202 communicate with each other through the router 35 and the router 36. Data flowing from the Mobile Application 201 into the router 35, is routed to either the Traditional Radio 112 and the Network A 204 or the SDR Software Controller system 109 and the SDR 100 and either the Network B 205 or the Network A 206. Each of the networks 204, 205, and 206 communicate with the router 36, which then forwards packets to the Host Application 202. Data flowing from the Host Application 202 into the router 36 flows in the reverse sequence as that described above.

The communication between the router 35 and the SDR Software Controller system 109 can be via well-known IPC (inter-process communication) mechanisms. The communication between the router 35 and the Traditional Radio 112 as well as the communication between the SDR Software Controller system 109 and the SDR 100 can also be via well-known IPC (inter-process communication) mechanisms. The communication between the router 35 and the Mobile Application 201 as well the communication between the Host Application 202 and the router 36, and the communication between the router 36 and the SDR Centralized Software Controller 111 can be via well-known Internet Protocol mechanisms. The communication between the router 36 and each of the networks 204, 205, and 206, as well as the communication between the Traditional Radio 112 and the Network A 204, as well as the communication between the SDR 100 and the Network B 205 and the Network C 206 are all specific to the nature of the networks 204, 205, and 206 and may be through well known IPC, well known Internet Protocol, or proprietary mechanisms, for example.

Subsystems:

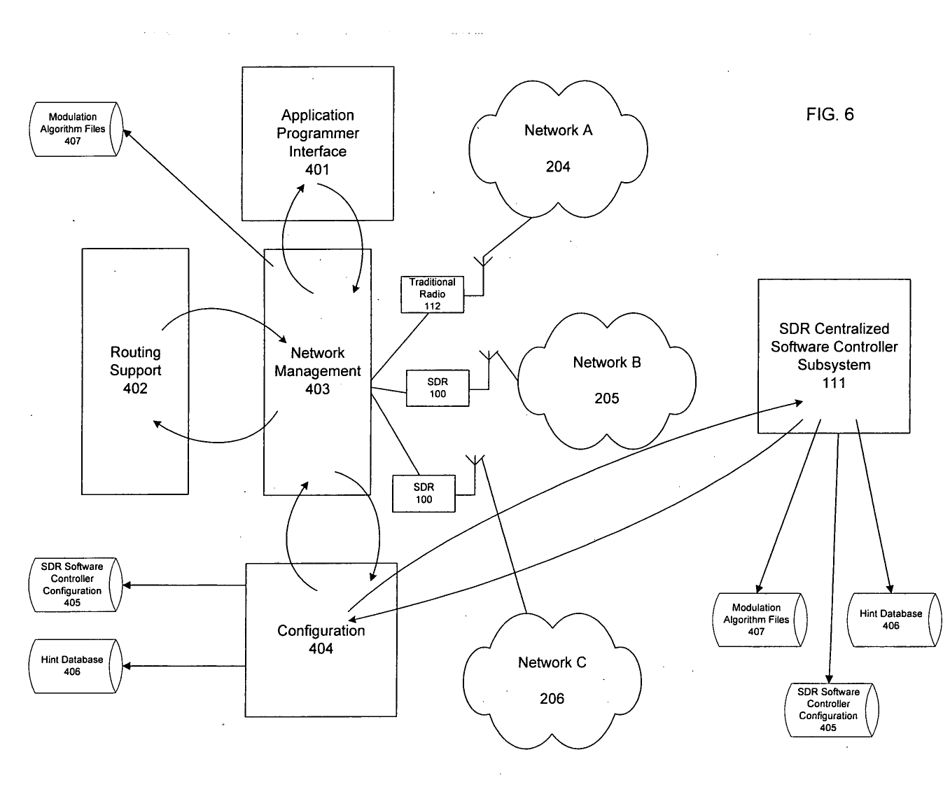

The SDR Software Controller system 109 can include four primary subsystems. These subsystems and their interaction are outlined in FIG. 6. Referring to FIG. 6, the Network Management subsystem 403 is the central subsystem. All other subsystems communicate with Network Management 403. Network Management 403 is responsible for managing the set of SDRs 100 that are controlled by this system 109. Network Management 403 processes both the Configuration 404 and the information gained through the Application Programmer Interface 401 to establish network connections, test the quality of the networks, and determine the optimal times to scan through the available modulation algorithms to find the best network. The Network Management subsystem 403 accesses Modulation Algorithm files 407 from persistent storage for downloading to the SDR devices 100.

Also referring to FIG. 6, a Routing Support subsystem 402 manages the transmission and reception of data packets over the set of SDR devices 100 and minimizes packet loss during periods in which this system 109 is scanning through its list of available modulation algorithms. Both the Configuration 404 and the Application Programmer Interface 401 subsystems implement this system's interactions with the external environment. Configuration 404 consists of an itemization of all configurable entities of the system 109 and their data structures as well as centralized administration and distribution. The Configuration subsystem 404 accesses the SDR Software Controller Configuration file 405 and the Hint Database 406 from persistent storage. The Application Programmer Interface 401 consists of the bidirectional interface through which external systems can exercise control over the behavior of this system 109 and through which those same external systems may acquire information regarding the internal state of this system 109 in order to change their own behavior.

Configuration:

In one embodiment, there are three types of configuration for this system 109. The first type of configuration is the set of actual program files 407 that make up the set of modulation algorithms to be used to configure the SDR 100. The second type of configuration is the SDR Software Controller configuration 405, which consists of the set of behaviors that describe how the SDR Software Controller system 109 will behave regarding startup, initialization of SDRs 100, and transitioning of modulation algorithms within an SDR 100. The third type of configuration is the Scanning Hint database 406.

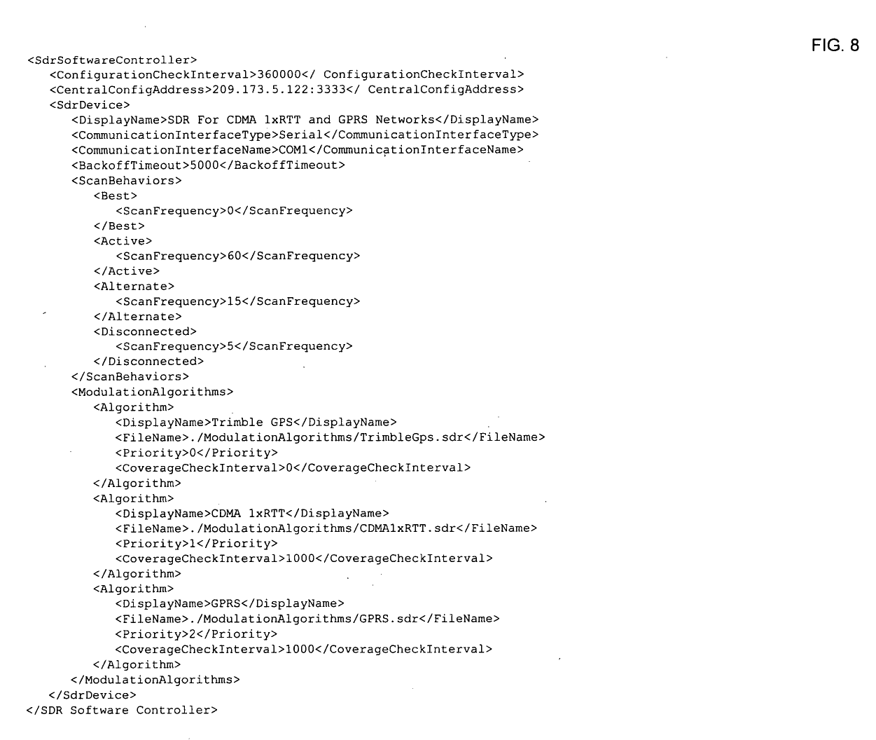

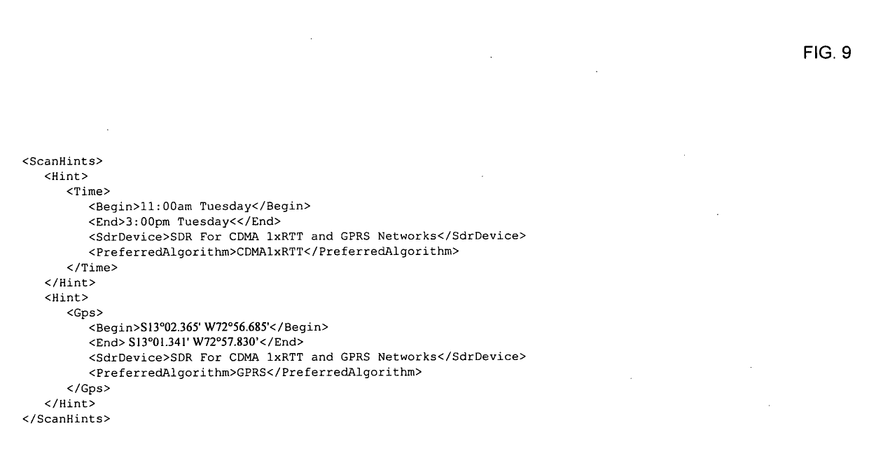

In one embodiment, other than the modulation algorithm program files 407, the configuration types may be represented in XML. FIG. 8 shows an exemplary SDR Software Controller configuration file and FIG. 9 shows an exemplary Scanning Hint Database configuration file. Following is a description of the purposes of each element of the data sets:
SdrSoftwareController—This entity represents the root node of the document under which all other configuration resides.
ConfigurationCheckInterval—This entity represents the interval at which the SDR Software Controller 109 will check with the SDR Centralized Software Controller 111 to see if there is any updated configuration to retrieve. A value of zero in this field disables communications with the SDR Centralized Software Controller 111.
CentralConfigAddress—This entity represents the IP/Port of the SDR Centralized Software Controller entity 111 if such an entity has been configured for this system 109.
SdrDevice—This entity represents the parent element of all configuration settings that apply to a single physical SDR 100.
Display Name—This entity represents the textual identifier by which the physical SDR unit 100 will be known through the system 109.
CommunicationInterfaceType—This entity represents the type of communication interface that may be used to access the SDR 100. By way of non-limiting example, the values of this entity could be Serial, NDIS, or some other standard or proprietary mechanism.
CommunicationInterfaceName—This entity represents the identifier by which the communication interface that is used to access the SDR 100 is known within the local operating system 110.
BackoffTimeout—This entity represents the amount of time, in milliseconds, after which a scan period will be aborted if an external party considered the previously active modulation algorithm to be the Currently Most Preferred Network and no new Currently Most Preferred Network notification has been received.
ScanBehaviors—This entity represents the parent node of all behavioral models configured for this SDR 100. Scan behaviors are not necessarily orthogonal. While it is true that the Disconnected state is orthogonal to all other states, and it is true that the Best and Alternate states are orthogonal, it is possible for the Best and Active and for the Alternate and Active states to overlap. For this reason, when states overlap, the behavioral settings should apply according to the following order: Best, Active, Alternate, Disconnected.
Best—This entity represents the set of behavioral parameters that should be activated whenever the SDR 100 has established connectivity to the highest priority modulation algorithm supported by the SDR 100. These behavioral parameters are considered to represent the behavior that should be assumed when network conditions are optimal.
Active—This entity represents the set of behavioral parameters that should be activated whenever the external entity that is registered with the API subsystem 401 has notified the SDR 100 that it considers the network associated with the currently loaded modulation algorithm to be its primary transport mechanism. These behavioral parameters are considered to represent the behavior that should be assumed while an external party such as router 35 is dependent on the connection.
Alternate—This entity represents the set of behavioral parameters that should be activated whenever the SDR has established network connectivity with a modulation algorithm, but that modulation algorithm is neither the highest priority modulation algorithm nor has an external entity provided an indication that it considers the current network to be its primary transport mechanism.
Disconnected—This entity represents the set of behavioral parameters that should be activated whenever the SDR 100 has not been able to establish a connection to a network using any of the configured modulation algorithms.
ScanFrequency—This entity represents the frequency, in milliseconds, that the SDR controller 109 will cycle through all of the configured modulation algorithms to test the network connectivity associated with each. If this value is set to zero, then scans will never be initiated while the SDR device 100 is in the associated state. In other words, if the value of this entity is zero, scanning will be disabled in the associated state.
ModulationAlgorithms—This entity represents the parent node for all configured modulation algorithms for this SDR 100.
Algorithm—This entity represents the parent node for all configuration details regarding a single modulation algorithm for this SDR 100.
DisplayName—This entity represents the textual identifier by which this modulation algorithm will be known through the system. For any external entity, such as the router 35, that is requesting status of connectivity to the various networks, this value will be the identifier for the network for which status is being reported.
FileName—This entity represents the name and location of the file that contains the modulation algorithm program that can be downloaded to the SDR 100.
Priority—This entity represents the preference of the modulation algorithm and the network that it represents relative to the set of all configured modulation algorithms that this SDR device 100 can support. The priority value is 1-based with 1 being the highest priority network modulation algorithm and each successive higher number being a successively lower priority. There is one special priority value, which is zero. A value of zero in this field indicates that the modulation scheme is the highest priority modulation scheme to check, but it is also not a network. Rather, it is a GPS modulation scheme.
CoverageCheckInterval—This entity represents the interval at which ongoing overt coverage checks will be performed against the network when the associated modulation algorithm is active. A value of zero disables overt coverage checking on the network accessed through this modulation algorithm such that only passive indications of link up or link down are used. Passive link indications are described later in this document within the description of the Network Management subsystem and its handling of network checking.

Referring to FIG. 9:
ScanHints—This entity represents the root node of the Scanning Hints database 406.
Hint—This entity represents a single hint record.
Time—This entity represents a time-based-hint record
GPS—This entity represents a positional-based-hint record
Begin—This entity represents the first boundary to which the hint applies. If the hint is a time-based-hint, then this entity represents the start time. If the hint is a positional-based-hint, then this entity can represent the top-left corner of a rectangular geographic region.
End—This entity represents the last boundary to which the hint applies. If the hint is a time-based-hint, then this entity represents the end time. If the hint is a positional-based-hint, then this entity can represent the bottom-right corner of a rectangular geographic region.
SdrDevice—This entity represents the identifier of the SDR device 100 to which this hint applies.
PreferredAlgorithm—This entity represents the actual hint itself. In effect, if the time is between the start and end times of a time-based-hint record, or if GPS data received is within the boundaries of the rectangular start and end coordinates of the positional-based-hint record, then this entity suggests that the system should prefer to check the indicated algorithm above all other algorithms regardless of any other configured priority for the modulation algorithms.

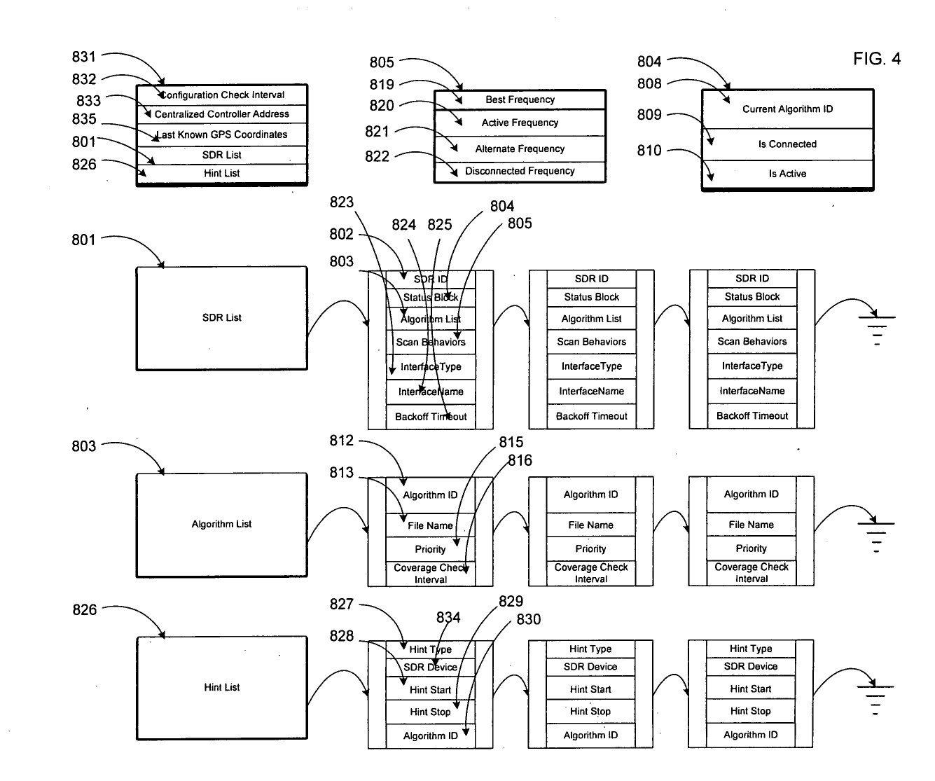

All of the configuration information outlined above is persistently stored and read into the system upon initialization. In memory, there are a set of data structures that hold the information from persistent storage as well as dynamic information that represents that actual run-time state. Exemplary in-memory data structures are outlined in FIG. 4. The description of each element will simply refer to the applicable element in the configuration file wherever applicable. A full description will be provided in cases in which there is no corresponding element from the persisted configuration file.

Referring to FIG. 4, the first data structure is the Configuration Block 831. This is a data structure that represents the root node of the rest of the configuration data structures. The structure contains the following elements.
Configuration Check Interval—This entity 832 corresponds to SdrSoftwareController.ConfigurationCheckInterval element of the configuration file.
Centralized Controller Address—This entity 833 corresponds to SdrSoftwareController.CentralConfigAddress element of the configuration file.
Last Known GPS Coordinates—This entity 835 represents the most up to date GPS coordinates that have been read from a GPS modulation algorithm. This entity will be initialized to an empty state and will never be populated unless a GPS modulation algorithm is configured for a controlled SDR device 100 and has been able to connect to the GPS network since the time that this system was initialized.
SDR List—This entity 801 is described below.
Hint List—This entity 826 is described below.

The SDR List 801 can be a linked list of structures that hold all of the static and dynamic information as it relates to a physical SDR device 100. Each element of the linked list 801 pertains to a single physical SDR device 100. Each structure can contain the following information.
SDR ID—This entity 802 corresponds to SdrSoftwareController.SdrDevice.DisplayName element of the configuration file.
Status Block—This entity 804 represents the block of information containing a dynamic state of the SDR device 100. This entity is populated at run-time.
Algorithm List—This entity 803 corresponds to SdrSoftwareController.ModulationAlgorithms element of the configuration file.
Scan Behaviors—This entity 805 corresponds to SdrSoftwareController.SdrDevice.ScanBehaviors element of the configuration file.
InterfaceType—This entity 823 corresponds to SdrSoftwareController.SdrDevice.CommunicationInterfaceType element of the configuration file.
InterfaceName—This entity 824 corresponds to SdrSoftwareController.SdrDevice.CommunicationInterfaceName element of the configuration file.
Backoff Timeout—This entity 825 corresponds to SdrSoftwareController.SdrDevice.BackoffTimeout element of the configuration file.

A second data structure is the Status Block 804. This can be a single structure that holds all of the dynamic information regarding a particular physical SDR device 100. The structure can contain the following information.
Current Algorithm ID—This entity 808 represents the identifying value of one particular modulation algorithm that is presently in use by a physical SDR 100. In one exemplary embodiment, it is the display name of the modulation algorithm.
IsConnected—This entity 809 represents the Boolean state of whether the current modulation algorithm is presently connected to its associated network.
IsPreferred—This entity 810 represents the Boolean state of whether an external entity, such as the router 35, considers the currently connected modulation algorithm to be its primary transport mechanism.

A third data structure is the Algorithm list 803. This can be a list of structures that holds all of the information, read from persistent storage, that describes all of the modulation algorithms that a particular physical SDR device 100 can support. The structure can contain the following information
Algorithm ID—This entity 812 corresponds to SdrSoftwareController.SdrDevice.ModulationAlgorithms.Algorithm.Display Name element of the configuration file.
File Name—This entity 813 corresponds to SdrSoftwareController.SdrDevice.ModulationAlgorithms.Algorithm.FileName element of the configuration file.
Priority—This entity 815 corresponds to SdrSoftwareController.SdrDevice.ModulationAlgorithms.Algorithm.Priority element of the configuration file.
Coverage Check Interval—This entity 816 corresponds to SdrSoftwareController.SdrDevice.ModulationAlgorithms.Algorithm.CoverageCheckInterval element of the configuration file.

A fourth data structure is the Scan Behaviors 805. This is a structure that holds all of the information, read from persistent storage, that describes the manner in which scanning will be performed in each of the states of the state machine that manages a physical SDR device 100. The structure can contain the following information.
Best Frequency—This entity 819 corresponds to SdrSoftwareController.SdrDevice.ScanBehaviors.Best.ScanFrequency element of the configuration file.
Active Frequency—This entity 820 corresponds to SdrSoftwareController.SdrDevice.ScanBehaviors.Active.ScanFrequency element of the configuration file.
Alternate Frequency—This entity 821 corresponds to SdrSoftwareController.SdrDevice.ScanBehaviors.Alternate.ScanFrequency element of the configuration file.
Disconnected Frequency—This entity 822 corresponds to SdrSoftwareController.SdrDevice.ScanBehaviors.Disconnected.ScanFrequency element of the configuration file.

In one embodiment, the active frequency is set to between 300,000 ms and 3,600,000 ms; and the best frequency is set to zero ms, unless GPS is desired. If GPS is desired, it is set to 300,000 ms. The alternate frequency can be set to between 60,000 ms and 300,000 ms; and the disconnected frequency can be set to 1 ms (unless battery is an issue in which case it should be more like 60,000 ms).

Another data structure is the Hint list 826, which can be stored in the Hint Database 406. This is a structure that holds all of the information, read from persistent storage, that describes the hints that the Network Management subsystem may use to drive the scanning process. The structure can contain the following information.
Hint Type—This entity 827 represents the type of hint being provided. This entity may be set with a value of either Positional (GPS), or Time (Ranges of times). Additional hint types are possible and are explicitly contemplated as being within the scope of the present invention. Examples of new hint types include Battery Power or Signal Strength trends over time.
SDR Device—This entity 834 corresponds to ScanHints.Hint.Time/Gps.SdrDevice element of the configuration file.
Hint Start—This entity 828 corresponds to ScanHints.Hint.Time/Gps.Begin element of the configuration file.
Hint Stop—This entity 829 corresponds to ScanHints.Hint.Time/Gps.End element of the configuration file.
Algorithm ID—This entity 830 corresponds to ScanHints.Hint.Time/Gps.PreferredAlgorithm element of the configuration file.

The SDR Centralized Software Controller 111 can centrally manage all types of configuration if the controller 111 exists in the system 109. The SDR Centralized Software Controller 111 can provide a repository of the current set of modulation algorithm program files, SDR Software Controller configuration files, and Scanning Hint Database files and make them available for retrieval by the SDR Software Controller system 109 from a centralized storage location using standard encrypted and authenticated file transfer techniques.

The SDR Software Controller configuration system 109 can be set up to operate with or without the SDR Centralized Software Controller system 111. The SDR Centralized Software Controller 111 serves the purpose of centrally storing, providing administrative access to, and distributing the configuration settings for this system 109. In this respect, its purpose is to alleviate some of the administrative overhead inherent in managing a mobile and potentially widely dispersed set of computing devices. The SDR Centralized Software Controller system 111 communicates with the router 36 for the purpose of centrally managing the SDR Software Controller configurations for mobile computing devices across the range of mobile computing devices already managed by the router 36.

The router 36 with which the SDR Centralized Software Controller 111 communicates is typically stationary whereas the router 35 with which the SDR Software Controller 109 communicates is potentially mobile. A one-to-many relationship exists between the SDR Centralized Software Controller 111 and the multiplicity of SDR Software Controllers 109. Therefore, all SDR Software Controller systems 109 communicate with one SDR Centralized Software Controller system 111 in systems in which the SDR Centralized Software Controller system 111 is present.

As an alternate embodiment, an SDR Software Controller system 109 that is associated with a potentially mobile router 35, may serve as the centralized configuration authority and assume the collocated role of both the SDR Software Controller 109 and the SDR Central Software Controller system 111. As a further alternate embodiment, an SDR Centralized Software Controller system 111 may be associated with a router 36 such that it is separate and distinct from the SDR Software Controller 109 and the router 35 but is still mobile in nature. An example of this type of configuration may be described as a mobile command center model.

Other than for the purposes described above, the SDR Software Controller system 109 may be wholly embodied on a single mobile computing device. One embodiment of this model would be if the SDR Centralized Software Controller system 111 were not present.

If, on the other hand, the SDR Centralized Software Controller were present, then a message model between a multiplicity of SDR Software Controller systems 109 and the single SDR Centralized Software Controller system 111 would be necessary. By way of non-limiting example, the message model may simply consist of the SDR Centralized Software Controller system 111 operating a secure FTP server on a well-known IP address through which SDR Software Controllers 109 connect upon startup to retrieve updated sets of modulation algorithms 407, the SDR Software Controller configuration file 405, and the Scanning Hint database 406. Other embodiments of this type of approach could include Secure Shell/Copy or a proprietary encrypted and authenticated file transfer mechanism. Moreover, through well-known directory storage or through relational database techniques, the SDR Centralized Software Controller 111 can provide customized configuration files that are specific to each SDR Software Controller system 109.

By way of non-limiting example, each system connecting to the FTP server described above may download the current configuration files from a directory with a name equal to the machine's domain name. If it were desired to share files across groups of domain names, shortcuts or shadow files could be created in each directory that wishes to share. Either way, upon retrieval and verification using MAC (Message Authentication Code) techniques, the local configuration files are overwritten and the local system continues its initialization sequence with the updated files.

The SDR Software Controller system 109 and, if included in the system, the SDR Centralized Software Controller system 111, require a configuration interface to provide control to system administrators to alter the behavior of the SDR Software Controller system 109. In one embodiment, this configuration interface is located on each system that includes the SDR Software Controller system 109. In an alternative embodiment, the configuration is only entered on the SDR Centralized Software Controller 111, and the mobile clients learn the configuration through the networks. This type of system has the advantage of reducing and centralizing the configuration required for the SDR Software Controller system 109.

If the operating system 110 on which the SDR Centralized Software Controller system 111 (or in the case of no SDR Centralized Software Controller system 111 then the operating system 110 on which the SDR Software Controller 109 runs) provides a graphical user interface, then the configuration can be performed using a GUI application collocated on the same host. If the system is installed on a device without a graphical user interface, then some other means may be used to provide access to the configuration settings. In one embodiment, the configuration information may be stored in XML files. Since XML files are textual, they may be easily edited directly by a human administrator. By way of non-limiting example, directly editing the text of the XML configuration file as represented in FIG. 8 and FIG. 9 may represent a suitable user interface for the system. In another embodiment, the configuration interface could be delivered via web protocols in a standard browser. In yet another embodiment, the configuration interface could be provided through a configuration file that is delivered to the system through the FTP protocol. In yet another embodiment, the configuration interface could be a published and well-known application programming or socket level interface.

Application Programmer Interface

The Application Programming Interface 401 provides the ability to publish and receive information. The API 401 also provides a mechanism whereby external entities can exercise dynamic control over the behavior of the system. The implementation mechanisms for the API 401 are numerous and well known. By way of non-limiting example, the API 401 could take the form of local sockets, named pipes with commonly understood marshalling techniques, shared libraries with exported functions, global memory with semaphore synchronization, among many others.

Following is an exemplary set of information that is published:
GpsStatusBlock
   Coordinates—This entity represents the buffer holding the raw data retrieved from the GPS device the last time that it was checked if a GPS modulation algorithm has been configured into the system.
NetworkStatusBlock
   DisplayName—This entity represents the textual identifier that can be used to represent the SDR 100 as it is operating under the context of a specific modulation algorithm.
   Status—This entity represents the Boolean indication as to whether the network is up or down.
PacketReceivedBlock
   DisplayName—This entity represents the display name of the modulation algorithm that the SDR 100 was currently operating with when the associated packet was received.
   Packet—This entity represents the buffer holding a new packet that has been received through the SDR 100 and must be delivered to the local system.

Following is the set of information that is received:
OnCurrentlyMostPreferredNetworkBlock
   DisplayName—This entity represents the display name of the network that an external entity is presently relying on as its primary transport mechanism.
PacketXmitBlock
   DisplayName—This entity represents the display name of the network on which the external entity would like to deliver the associated packet.
   Packet—This entity represents the buffer holding the packet to be delivered.
OnHintBlock
   Action—This entity represents the action that should be taken against a hint. Its value will either be “Add” or “Remove”.
   Hint Type—This entity represents the type of hint being supplied. In one embodiment, its value will either be “Time” or “GPS”.
   Hint Start—This entity represents the starting value for the band within which the hint applies. For Time-based hints, this value will be a timestamp. For GPS-based hints, this value can be a GPS coordinate representing the top-left corner of a rectangular region.
   Hint Stop—This entity represents the ending value for the band within which the hint applies. For Time-based hints, this value will be a timestamp. For GPS-based hints, this value can be a GPS coordinate representing the bottom-right corner of a rectangular region.
   SDR Display Name—This entity represents the identifier for a physical SDR device 100 to which this hint applies.
   Modulation Algorithm Display Name—This entity represents the hint itself. The value of this field will identify the modulation algorithm that should be preferred when the system exists within the band suggested by the Hint Start and Hint Stop fields.

Following is an exemplary set of information that can be provided by external entities to exercise dynamic control over the system:
ConfigurationBlock
   Configuration—This entity represents the SdrSoftwareController configuration block. An exemplary description of the SdrSoftwareController configuration block is provided in FIG. 8.
   Timeout—This entity represents the duration, in milliseconds, until the original configuration block takes effect. The implementation of this system should enforce a maximum timeout for validation purposes. In one embodiment, this maximum timeout may be set to 60000 milliseconds. In this example, in order to apply a new configuration for a longer duration, multiple successive calls must be made to the API 401.

It should be noted that the use of the ConfigurationBlock API should be authenticated. According to an aspect of the present invention, shared secret keys are used for encryption. The administration of the shared secret is performed using well known key management techniques the discussion of which are outside the scope of this description.

It should also be noted that the use of this API 401 provides for the ability to integrate the capabilities of this API 401 into further APIs, such as those available with the router 35, in a layered proxy fashion. It should also be noted that the use of this API 401 provides for the ability to integrate the capabilities of this API 401 into the functionality provided by inventions such as previously noted U.S. Patent Application Publication No. 2004/0170181 A1, entitled “Prioritized Alternate Port Routing”, the disclosure of which is expressly incorporated by reference herein in its entirety.

Network Management:

The Network Management subsystem 403 uses the Configuration 404 and the information gained through the Application Programmer Interface 401 to establish network connections, test the quality of the networks, and determine the optimal times to scan through the available modulation algorithms to find the best network.

The Network Management subsystem 403 is responsible for scanning across the available modulation algorithms for each SDR 100, checking the quality of the network available through each modulation algorithm, choosing the best network at any point in time, and rescanning on the appropriate frequency. In addition, this subsystem 403 is responsible for monitoring the network quality on an ongoing basis, initiating a rescan whenever connection is lost, and notifying internal and external entities whenever the status of the controlled networks changes.

In addition to monitoring and publishing the internal state of the networks through the previously mentioned application programming interfaces 401, the SDR Software Controller system 109 must also understand the state of any external dependencies that entities outside of this system, such as the router 35, have on any currently active networks. When an external entity, such as the router 35, has a dependency on a currently active network, it notifies this system through the API subsystem 401 and designates the network as the Currently Most Preferred Network. This functionality is described in patents like U.S. Pat. Nos. 6,198,920, and 6,418,324, discussed above, the disclosures of which are expressly incorporated by reference herein in their entireties. Both the internal network status information and the external network dependency information is important for the SDR Software Controller system 109 since it is required to dynamically change its “Scan Behaviors” in response to dynamic changes of the network status or network dependencies.

The SDR Software Controller system 109 communicates with the router 35 for the purpose of managing the SDR 100 connectivity state. The router 35 benefits from this communication in that the SDR Software Controller system 109 will establish and make available additional communication links for the router 35 to use as transport mechanisms. The SDR Software Controller system 109 benefits from this communication because the information is used to understand which networks the router 35 is dependent upon for data transport. The SDR Software Controller system 109 uses this information from the router 35 along with its own Configuration 404 (whether configured locally or retrieved from the SDR Centralized Software Controller 111) to determine the true state of each SDR 100 being controlled.

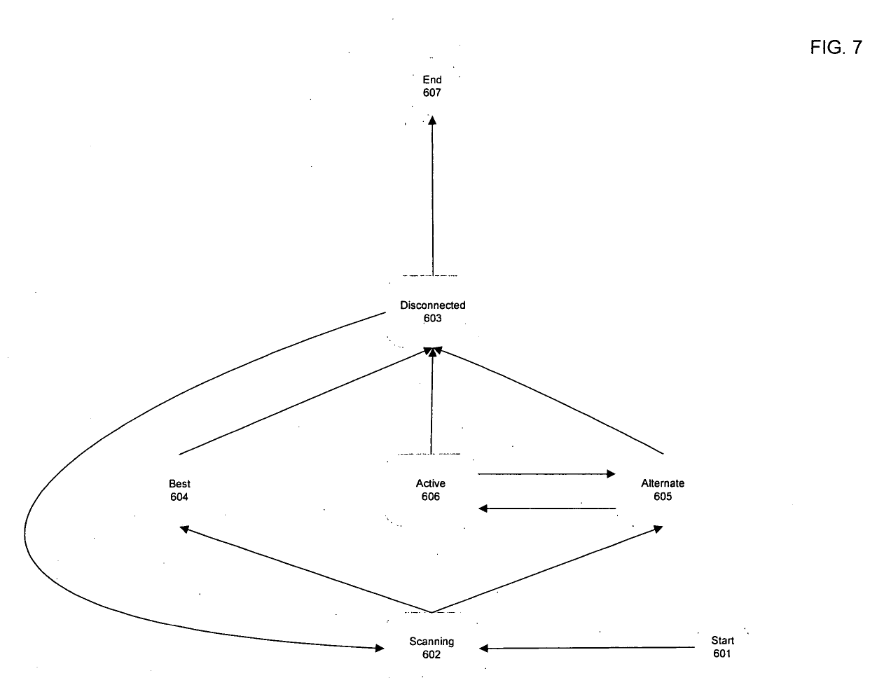

An exemplary state transition diagram is shown as FIG. 7. This diagram provides a view of the various states that a particular SDR 100 being controlled by the SDR Software Controller 109 may exhibit. Bear in mind that an individual SDR Software Controller 109 may actually control multiple physical SDRs 100. In this case, there would simply be multiple state machines each operating independently. This diagram also provides a view of the possible transition paths that an SDR's state may take from the perspective of the SDR Software Controller system 109.

Referring to FIG. 7, when the SDR Software Controller system 109 initializes an SDR 100, the state machine enters Start 601. From this point, an immediate state transition occurs from Start 601 to the Scanning state 602. In this state, the SDR Software Controller system 109 is cycling through the configured modulation algorithms, in the configured priority order, until it connects to a network.

Once the SDR has connected to a network using one of its configured modulation algorithms, the system 109 checks its Configuration 404 to determine the relative priority of the active modulation algorithm. If the connected modulation algorithm is the highest priority modulation algorithm configured for the SDR 100, then a state transition occurs from Scanning 602 to Best 604. If, on the other hand, the connected modulation algorithm is not the highest priority modulation algorithm configured for the SDR, then a state transition occurs instead from Scanning 602 to Alternate 605. Once Best 604 or Alternate 605 states have been achieved, an external party such as a router 35 may inform this system that it considers the currently connected network to be the Currently Most Preferred Network. If this notification is received while the SDR 100 is in the Alternate 605 state, then a further transition will occur from Alternate 605 to Active 606. No such transition will take place from Best 604 to Active 606 since the Best state 604 is higher priority than the Active state 606 when these two states overlap. It is also possible for the external party, such as router 35, to notify this system that it no longer considers the established network connection to be its Currently Most Preferred Network. In a situation such as this, a further transition will occur from Active 606 back to Alternate 605.

Once an established connection has settled into a connected state, and aside from transitions between Active 606 and Alternate 605, the only remaining state transition is to Disconnected 603. This transition may occur due to natural drops in network connectivity or because the SDR Software Controller system 109 wishes to re-enter scanning mode according to its configured Scan Behaviors for the previous state. In either case, an immediate state transition occurs from Disconnected 603 to Scanning 602 where the full scan process occurs again from the highest priority modulation algorithm to the lowest.

Alternatively, if the Scanning Hint Database 406 is present, and there is a record contained in the database 406 that applies to either the current time or the current geographic location, the strict priority order configured for the modulation algorithms may be violated. Whenever a scan is initiated for an SDR device 100 and an applicable hint is present, then the modulation algorithm associated with that hint will be temporarily elevated to the highest priority modulation algorithm. If multiple hint records are detected, the relative order of the temporarily elevated priorities will be set in the order in which the hints are found. For example, the first hint found will have the highest temporary relative priority. The next hint found will have the second highest temporary relative priority. Even so, once the hints have been processed first, then the scanning will resume from the highest configured priority to the lowest skipping any that were already checked due to hints. Further, the sheer presence of a configured hint that is applicable at any specific point in space or time will initiate a scan. Once the scanning state connects to a network, it follows the state transitions indicated above. If the transition from a connected state to the disconnected state occurred due to a system shutdown, then no transition back to Scanning 602 will take place and the system will instead transition to End 607.

Once a given modulation algorithm has been loaded into the SDR 100, many methods exist to determine the quality of the network connection. For standards based networks, standard approaches can be used. By way of non-limiting example, on standard IP based networks that are visible to the operating system's IP stack, techniques such as checking whether the IP stack in the operating system has been able to acquire a valid lease from a DHCP server can provide indication of adequate network quality. Additionally, listening for default Router Advertisements (as described in RFC 1256, the disclosure of which is expressly incorporated by reference herein in its entirety) can provide an indication of network quality.

Also, a variety of link layer indications can be used. Often, the link layer indications are specific to the network. So, for these types of situations, the solution will be to work with the SDR vendors to construct SDR software programs that can translate the link quality as known in the SDR unit 100 itself into a generic binary link indicator native to the interface mechanism used to access the SDR 100. By way of non-limiting example, this could include the OID_GEN_MEDIA_CONNECT_STATUS indicator published by all Windows Network Driver Interface Specification (NDIS) compliant miniport devices or it may include the state of the DCD line for a serial RS-232 interface.

In yet another embodiment, so long as the SDR 100 offered two access interfaces, one for control access and one for network access, then the SDR Software Controller system 109 and the router 35 could collaborate. In this case, the SDR Software Controller system 109 would manage the setup and scanning of the modulation algorithms on the SDR 100. The router 35 would test the viability of the network that had been set up and publish status in the same way that the API's 401 of this system 109 publish status. The SDR Software Controller system 109 would operate as specified previously only having used the published status from the router 35 as its own status of the network.

The same manner to check a network initially will be used on an ongoing basis according to the configuration settings for the active modulation algorithm. Whenever the Network Management subsystem 403 detects a change in status for a particular modulation algorithm within the SDR 100, it will be responsible for publishing that updated status via the Application Programmer Interface 401.

If the modulation algorithm that was loaded into the device 100 was a GPS modulation algorithm (configured priority value of zero), then the algorithm will only remain loaded for the time it takes to issue a query and receive a response for the current GPS coordinates. Once this is completed, the modulation algorithm will be disconnected and the scanning will move on to the modulation algorithm configured with a priority of one. These coordinates will be retained so that they can be provided to external entities via the API 401. It is the combination of the GPS and the Network Status API publications that allow an external entity to update the Scanning Hint Database 406 for either time-of-day hints or positional-hints. The Scanning Hint database 406 may be updated through the API 401, as described previously.

Whenever the SDR Software Controller 109 is managing multiple SDR devices 100, whether the multiplicity is achieved through multiple RF transmitters/receivers in the same device 100 or it is achieved through multiple physical devices 100, the controller 109 will work to ensure that each distinct type of modulation algorithm is connected to only a single SDR device 100 at a time. In other words, no two physical SDR devices 100 should be able to designate the same modulation algorithm to be the active modulation algorithm at the same time. This is accomplished in the following manner. Whenever the state machine associated with a particular SDR device 100 enters a scanning state, the scan progresses through the complete list of modulation algorithms supported for that device. However, if any other SDR device 100 has already marked an algorithm as connected, and that algorithm is also listed in the supported algorithms for the current SDR device 100, then that algorithm will be pruned from the list of algorithms over which to scan. In this way, no SDR devices 100 will scan for networks that are already connected to another SDR device 100.

Routing Support

The Routing Support subsystem 402 is a virtual subsystem whose responsibilities are actually implemented within the context of the Network Management 403 and API 401 processing. The virtual subsystem 402 responsibilities consist of a messaging and scan-backoff mechanism to minimize the extent of lost packets that may occur during a scan period as well as an avenue through which external parties can send and receive data packets through this system 109. The messaging mechanism is a behavior of one aspect of this invention in which external entities are made aware of changes in the status of the various networks that are accessible through this system 109. The scan-backoff mechanism is a behavior of one aspect of this invention in which in-progress scans may be aborted after a period of time in order to minimize packet loss. In one embodiment, the backoff timeout should be set to one tenth of the Active Scan Frequency. In this case, if the Active Scan Frequency were set to 300,000 ms, then the Backoff Timeout would be 30,000 ms or 30 seconds.

When the system 109 determines that it is time to perform a scan of available modulation algorithms, the system 109 first checks the status of the active modulation algorithm. If the active modulation algorithm has not been deemed the Currently Most Preferred Network by an external entity, no backoff processing will take place, only messaging. In this situation, the external party is simply notified through the API mechanisms described earlier that the network associated with the currently active modulation algorithm is out of coverage. After this API notification is sent, the active network is disconnected and the scan operation is invoked.

If, on the other hand, the active modulation algorithm has been deemed as the Currently Most Preferred Network by an external entity, then this subsystem 402 will also, as indicated above, perform the API notification and scan processing. However, it will also wait for the configured period for a new Currently Most Preferred Network notification via the API 401. If no new Currently Most Preferred Network notification is received within the configured time period, then the scan operation will be aborted and the previous Currently Most Preferred Network will be resumed. If the configured timeout period is set to zero, then processing associated with scanning through the modulation algorithms is suspended whenever the active modulation algorithm is the Currently Most Preferred Network.

In addition, the Routing Support subsystem 402 is the recipient of any calls made to the API 401 to transmit a packet over a particular SDR 100 connected to a network using a particular modulation algorithm. The SDR 100 may be accessible through a mutually exclusive interface port on the platform. By way of non-limiting example, such a mutually exclusive interface port may represent a serial port. In a situation such as this, the only way to push data into the SDR 100 is through the entity that owns the interface port. An external entity can route traffic through such a device by utilizing this subsystem 402. In an alternate embodiment, the SDR 100 may be accessible through standard approaches that may be shared by multiple processes. By way of non-limiting example, such approaches may include socket calls. In a situation such as this, the external application may choose to route the traffic itself, or it may choose to utilize this subsystem.

Similarly, the Routing Support subsystem 402 is the originator of any calls made to the API 401 that signal to an external entity that a data packet has been received. As indicated above, depending on the type of interface to the SDR 100, such a received packet may be routed to the external entity directly, or, in the case of a mutually exclusive interface port, such a received packet may only be routable to the external entity through propagation through this subsystem 402 and then through the API 401.

In addition, the design of this system does not in anyway preclude the ability to maintain multiple simultaneous network connections so long as the SDR 100 supports multiple RF transmitters/receivers or multiple physical SDR devices 100 are connected to the host. Specifically, the API 401 provides the flexibility to support multiple in-coverage SDR managed networks and multiple SDR data blocks within the Configuration 404. In addition, the state machine for an individual SDR 100 is fully independent and can be run in parallel with the state machines associated with other SDR transmitters/receivers. Although only a single modulation algorithm on a single SDR device 100 can be designated as Currently Most Preferred Network at any one time by an external party, this does not preclude the ability for that external party to use additional networks simultaneously for the transmission and/or receipt of data packets.

The API's, configuration, and runtime operation of this system 109 provide status information at the network level granularity rather than the granularity of groupings of networks that can be supported, one at a time, by a single physical device, effectively translating the single-device-multiple-network-support data model to the single-network-logical-device data model. Such a split in granularity allows systems to separately manage, route through, and prioritize the logical network devices presented by this system 109.

Process Flow

An exemplary process flow of data through the SDR Software Controller system 109 is now described.

Initialization

Upon startup of the SDR Software Controller system 109, all data structures are initialized. The local copy of the SDR Software Controller Configuration file 405 will be read, validated, and loaded into the applicable in-memory data structures (FIG. 4). Part of the validation routines include verifying that the local copies of each of the modulation algorithm program files identified in the SDR Software Controller Configuration file 405 actually exist in the location indicated in the configuration. Any modulation algorithm files that are not present will be removed from the in-memory configuration data structures although they will remain configured in persistent storage. Missing files will also result in error messages being posted to the error log of the local operating system through well known mechanisms. The local copy of the Hint Database 406 will also be read, validated, and loaded into applicable in-memory data structures (FIG. 4).

Once all of the configuration data has been read into memory and its contents validated, each physical SDR device 100 defined in the configuration will be accessed through the interface port specified. If access to the SDR device 100 is denied for any reason, the event will be logged to the standard error log on the operating system 110 and the offending SDR device 100 will be removed from the configuration loaded into memory. In one embodiment, the configuration of the device 100 shall, however, remain in the persistent copies of the configuration file on the machine.

Once all of the physical SDR devices 100 have been accessed, the SDR Software Controller system 109 will start the different operating system threads to manage the activities within the system 109. By way of non-limiting example, the actual implementation of the subsystems described below may take the form of separate threads within the same process, separate processes on the same computing device, separate processes distributed across multiple computing devices, or a combination thereof. For the purpose of this description, all of these exemplary embodiments will hereafter be collectively referred to as threads. The following threads may be started:
Configuration—This thread will be responsible for waking up periodically and checking with the SDR Centralized Software Controller 111 to see if there is updated configuration data to retrieve.
Application Programmer Interface—This thread will be responsible for interacting with external parties regarding dynamic changes to system state.
Network Management—This thread will be responsible for monitoring the set of configured SDRs 100 and their associated network status and for managing scan processing.
   Configuration

Once the system has been initialized, most of the responsibility of the Configuration subsystem 404 will have been completed. In one embodiment, after initialization, the Configuration subsystem 404 will only perform two additional responsibilities. The first responsibility will be to manage the in-memory configuration structures by providing controlled access to them and updating them if the persistent configuration files ever change. Monitoring the configuration data files for change events will take place through well known mechanisms provided by most modern operating systems. The other responsibility of the Configuration subsystem 404 will be to periodically wake up and access the SDR Centralized Software Controller 111 if one has been configured. The Configuration subsystem 404 will wake up according to the period defined by the ConfigurationCheckInterval 831. The Configuration subsystem 404 will check for new configuration entities by accessing the SDR Centralized Software Controller 111 at the configured address (CentralizedControllerAddress 833). If the ConfigurationCheckinterval 831 is set to zero, this capability will be disabled. If the value of this setting is non-zero, then the CentralizedControllerAddress must resolve to a valid IP/Port. If new configuration entities are found to be available, they will be downloaded to the local configuration storage 405, the system shall be shut down gracefully, and the system will be reinitialized as indicated above.

Application Programming Interface

After system initialization, the Application Programming Interface (API) subsystem 401 is ready to begin servicing requests.

In order to receive status notifications from the API subsystem 401, an external party must first register with the subsystem 401. The mechanism for registration is dependent upon the mechanism used to access the API 401. As indicated above, the mechanism could take the form of IP packets, a shared library, or any number of commonly used approaches. Regardless of the approach, all external recipients of status must first register in order to receive the status updates. Correspondingly, once the external party no longer requires status updates, they must unregister. By way of non-limiting example, one method of registration/unregistration may be the establishment of a TCP session between the external entity and the API subsystem 401. The advantage of an approach such as this is that unregistration is automatic. Presently, according to an aspect of the present invention, only a single consumer to the API is supported. In an alternate embodiment, multiple registered consumers may be supported.

Whenever the API subsystem 401 has new information to publish, it will do so to all registered consumers of the API 401. In one embodiment, there are three types of information that are published and they are all received by the API subsystem 401 from the Network Management subsystem 403. All three types of information have been previously described in this document under the Application Programming Interface subsystem description.
GpsStatusBlock
NetworkStatusBlock
PacketReceivedBlock

Once the API subsystem 401 starts up, its thread enters a waiting state. Whenever a new consumer registers with the API 401, the API 401 stores the address of the consumer's callback mechanism. In the example listed above, this would consist of the local TCP socket on which the consumer's connection was accepted. Afterwards, the API subsystem 401 re-enters its waiting state for additional consumer registrations, existing consumer unregistrations, or data to be published or received.

Whenever the API subsystem 401 receives information to be published from the Network Management subsystem 403, it cycles through the list of registered consumers propagating the information to all of them.

Just as the API subsystem 401 waits for information to be published by the Network Management subsystem 403, it also waits for information to be accepted from external entities. In one embodiment, there are four types of information that are accepted from external entities. All four types of information have been previously described in this document under the Application Programming Interface subsystem description.
OnCurrentlyMostPreferredBlock
PacketXmitBlock
OnHintBlock
ConfigurationBlock

When the API 401 receives an OnCurrentlyMostPreferredBlock notification from an external entity, it cycles through the SDR List and through the Algorithm List of each entry in the SDR List, looking for an entry that corresponds to the identifier provided. If it finds that identifier, it verifies that the identifier represents a connected modulation algorithm for a known SDR device 100. If neither is true, the API call fails and a failure indication is returned to the caller. If both are true, then the API 401 clears any existing Currently Most Preferred Network flags on any modulation algorithms for any SDR devices 100 and turns on the flag for the modulation algorithm identified in the API call.

When the API receives a PacketXmitBlock notification from an external entity, it cycles through the SDR List and through the Algorithm List of each entry in the SDR List, looking for an entry that corresponds to the network identifier provided. The PacketXmitBlock contains both the actual packet data buffer as well as an identification of the network over which the packet buffer should be transmitted. If it finds that identifier, it verifies that the identifier represents a connected modulation algorithm for a known SDR device 100. If neither is true, the API call fails and a failure indication is returned to the caller. If both are true, the API will provide the packet to the Network Management subsystem 403 for transmission over the network. When the API 401 receives an OnHintBlock notification from an external entity, it will either add or remove an element from the Hint Database 406 data store. Regardless of the type of hint action (Add/Remove), the API 401 will take several preliminary steps. First, the API 401 will validate that the SDR device 100 and modulation algorithm supplied actually exist within the Configuration subsystem 404. If either entity does not exist, the action will be aborted and the API 401 will return a failure code to the caller. If both entities exist, the next step that the API 401 will take will be to search for an existing entry with the same hint type, hint start, hint stop, SDR device 100, and modulation algorithm (in other words, all hint fields are equal). If the hint action supplied was to Add the hint and no duplicate hint is found, then the hint is added. Otherwise, the action is aborted and the API 401 will return a failure code to the caller. If the hint action supplied was to Remove the hint and no duplicate hint is found, then the action is aborted and the API 401 will return a failure code to the caller. Otherwise, the hint is removed from the Hint Database 406.

When the API 401 receives a ConfigurationBlock notification from an external entity, it will reinitialize the system, as described above, with the configuration data that was supplied. It will also start a timer. When the timer expires, the system will reinitialize once again with the configuration data from persistent storage. In this respect, any new Configuration that is received through the API subsystem 401 will result in a temporary setup only. Once the timer associated with the received configuration expires, the setup of the system will revert to the original configuration.

Network Management

Once the system is initialized, the Network Management subsystem 403 will perform most of the substantial work in the system. In one embodiment, the Network Management subsystem 403 is responsible for the following actions:

Scanning through modulation algorithms on an SDR device 100.
Checking network quality on all networks that are accessible through a modulation algorithm that has been downloaded to an SDR device 100.
Providing network status notifications to the API subsystem 401.
Providing packet received notifications to the API subsystem 401.
Providing GPS received notifications to the API subsystem 401.
Processing packets that must be sent to the network accessible through a particular modulation algorithm loaded into an SDR device 100.

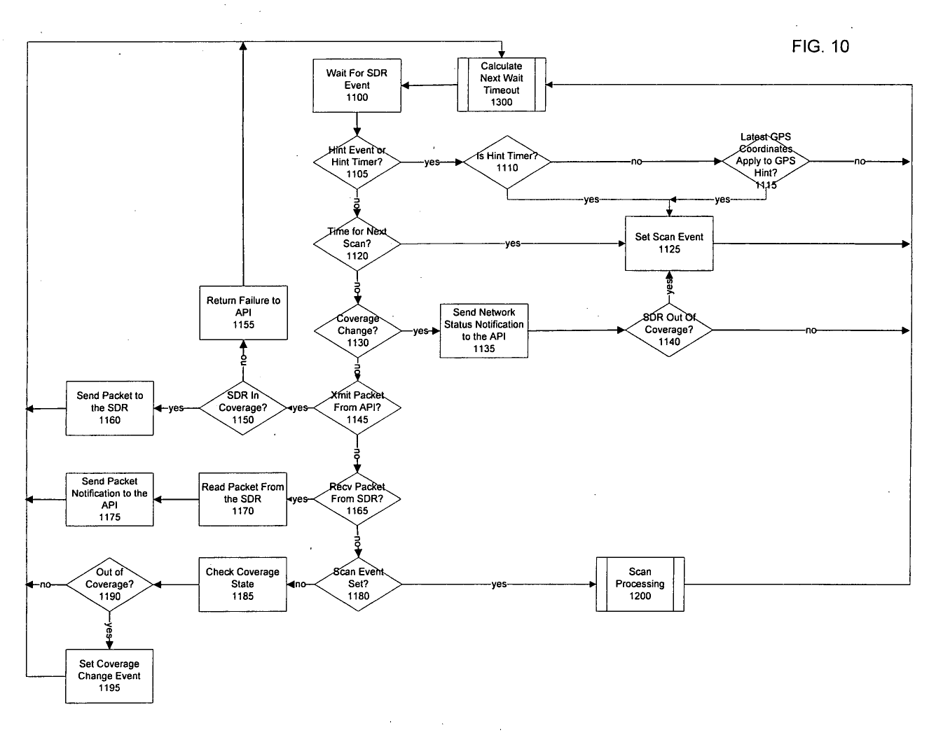

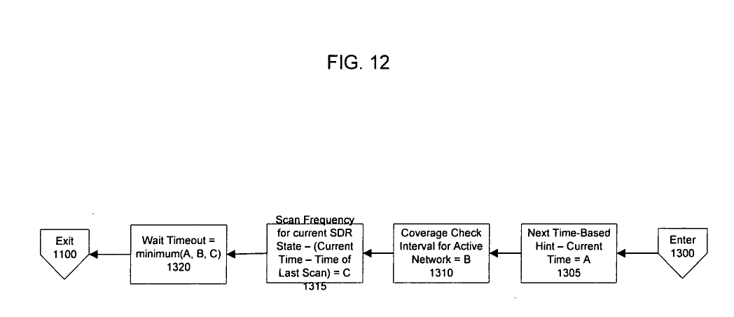

The Network Management subsystem 403 will manage a set of operating system threads or processes with one thread or process for each controlled physical SDR device 100. FIG. 10 depicts an exemplary flow chart of one embodiment of this aspect of the invention. Multiple threads or processes may be simultaneously operating at various steps in the flow against distinct SDR devices 100. Referring to FIG. 10, the process starts at Calculate Next Wait Timeout 1300. This first step is actually exemplified by a further flow that is depicted on FIG. 12.

Referring to FIG. 12, a first value is calculated as the start time associated with the next Time-Based Hint that will apply according to chronological order minus the current time (1305). This value is recorded as “A”. If there are no applicable Time-Based Hints, this value is recorded as the maximum value for the data type. Next, a second value is calculated, at step 1310, as the coverage check interval for the currently active modulation algorithm. This value is recorded as “B”. If there is no currently active modulation algorithm, this value is recorded as the maximum value for the data type. Next, a third value is calculated, at step 1315, as the configured scan frequency for the current state of the SDR 100 minus the result of the current time minus the time of the last scan that took place. This value is recorded as “C”. Finally, the minimum of A, B, and C is used and considered to be the current Wait Timeout value.

Now that the current Wait Timeout is known, we refer once again to FIG. 10. The next step in FIG. 10 is the Wait For SDR Event 1100 step. Once an SDR Event is detected or a timeout has occurred, the result of 1100 is inspected. The first check will be to determine whether it is a hint event or whether the wait timeout for the next time-based hint has fired (1105). If one of these conditions is true, the condition will be further examined to determine if the cause was specifically due to the hint timer (1110). If this is the case, then the scan event will immediately be set and processing will return to the Wait For SDR Event (1100) step. If this is not the case, then the latest stored GPS coordinates will be examined to determine if they overlap a configured positional-based hint (1115). If this is the case, then the scan event will immediately be set and processing will return to the Wait For SDR Event (1100) step.

If neither the Hint Event nor the Hint Timer has fired, the next step will be to determine if enough time has passed in the current state from the previously mentioned state machine to warrant a pre-emptive scan (1120). If this is the case, it will proceed to the Set Scan Event step (1125) before moving back to the Wait For SDR Event step (1100). If it is not a Time For Next Scan (1120), then the SDR Event will be further inspected to determine if it is a coverage change event (1130). If it is, then the process will Send Network Status Notification to the API (1135). Afterwards, it will determine if the coverage change was due to an out-of-coverage condition (1140). If so, then the process will set the Scan Event (1125). In either case, the next step will be to return to the Wait For SDR Event step (1100).

If the event is not a coverage change event, then the process will next check to see if the event is a Xmit Packet From API (1145) event. If this is the case, it will first check to see if the specified SDR is in coverage (1150). If the SDR is not in coverage, the process will return a failure code back to the API subsystem (1155) before returning to the Wait For SDR Event (1100) step. If it is in coverage, then flow will proceed to the Send Packet to the SDR step (1160) before proceeding back to the Wait For SDR Event (1100) step.

If the event is not an Xmit Packet From API (1145) event, then the process will check to see if the event is a Recv Packet from SDR (1165) event. If it is, then the packet will be read from the SDR (1170) and a packet received notification will be sent to the API (1175) before finally returning to the Wait For SDR Event 1100 step.

Finally, the event will be inspected to determine if it is a Scan Event that has been set (1180). If it is not, then flow will proceed to the Check Coverage State step (1185) in which coverage will be checked on the currently connected modulation algorithm. In effect, if the Wait For SDR Event step (1100) is interrupted, but it is not interrupted due to any of the previously checked events, the default behavior will be to check the coverage state of the currently connected network (1185). If the coverage check determines that the network is still in coverage (1190: NO), then flow will proceed back to the Wait For SDR Event step 1100. If the coverage check determines that the network is no longer in coverage (1190: YES), then the Coverage Change Event (1195) will be set before proceeding back to the Wait For SDR Event step 1100.

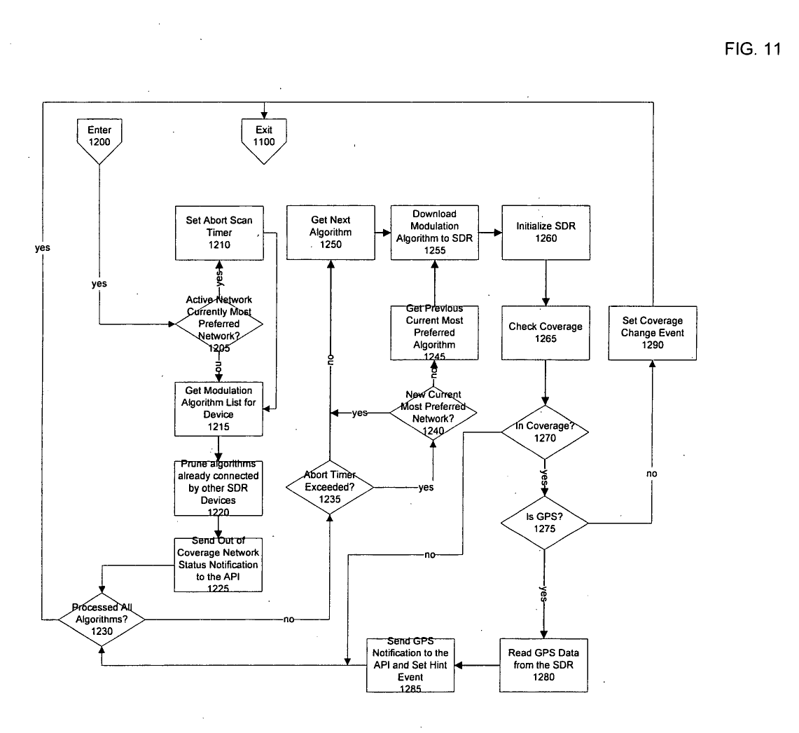

If the event is actually a Scan Event (1180), then flow will continue to Scan Processing (1200). In one embodiment, Scan Processing operates according to the flow chart described in FIG. 11. Referring to FIG. 11, the first check made will be to determine whether the currently connected modulation algorithm has been designated as a Currently Most Preferred Network by an external party (1205). If it has, then an abort timer will be set up (1210). If not, or after the abort timer has been set up, the list of supported modulation algorithms for the device will be retrieved from the Configuration subsystem (1215). Step 1215 includes the processing associated with retrieving any applicable hints and merging the algorithms associated with those hints with the standard prioritized list of algorithms for the SDR device in the manner described earlier. Immediately after step 1215, the generated list will be pruned in step 1220 to remove any modulation algorithms with which connections are currently active and maintained by other SDR devices.

Next, after step 1220, an out of coverage notification will be sent to the API subsystem (1225) for the currently connected modulation algorithm if one is currently connected on the present SDR device because each SDR receiver only handles one algorithm at a time. Afterwards, a loop will be entered in which all algorithms in the list will be processed until either the end of the list is reached (1230: YES) or a viable network has been connected and the coverage event has been set (1290). With each iteration of the loop, the abort timer shall be checked (1235). If the abort timer has been exceeded, then a further check will be made (1240) to determine if a new Currently Most Preferred Network has been designated by an associated external entity through the API subsystem. If a new Currently Most Preferred Network is present, then processing will continue through the loop. If no new Currently Most Preferred Network is present, then the previously active modulation algorithm will be downloaded to the device (1245/1255). Otherwise, the next highest priority algorithm that has not yet been evaluated will be downloaded to the device (1250/1255).

Once an algorithm has been downloaded (1255), and the SDR device is initialized (1260), the coverage state will be tested (1265). If the SDR running the current modulation algorithm is not in coverage (1270: NO), then the next iteration of the loop will be processed by returning to step 1230. If the SDR running the current modulation algorithm is in coverage (127: YES0), then a check will be made as to whether the current algorithm is a GPS algorithm (1275). If it is not a GPS algorithm, then the coverage change event will be set (1290) and flow will return to the Wait For SDR Event (1100) step. Otherwise, the current GPS data will be read from the device (1280), the data will be delivered for notification to the API subsystem and the hint event will be set (1285), and the next iteration of the loop will be processed by returning to step 1230.

According to an aspect of the present invention, a method is provided for enabling seamless roaming over multiple dissimilar wireless networks while using a set of one or more SDRs in combination with zero or more traditional radio communication devices. The capabilities described herein provide for intelligent checking of alternate network availability while minimizing any disruption that such checking may cause for any dependent external entities. Capabilities are provided to optimize the checking of alternate network availability when the SDR provides multiple transmitters and receivers or when multiple distinct SDRs are available to the mobile computing device. In addition, another aspect of this invention calls out the ability to establish multiple, simultaneously active networks when a multiplicity of SDR transmitter/receivers are present. According to an aspect of the invention, functionality is provided to manage the network checking behavior programmatically through a published API. A means is provided to integrate, via the aforementioned API, the coverage checking behavior with existing wireless middleware solutions. According to yet another aspect of the present invention, the system behavior can be configured to minimize packet loss during periods in which external entities are dependent on the connections established by this system. Also, an aspect of this invention provides for management of the configuration database of this solution, both locally within the mobile node, and centrally within a configuration database gateway.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., IP version 4, IP version 6, UDP/IP, TCP/IP, ICMP), and wireless networking (802.11a, 802.11b, 802.11g, UWB, CDMA 1xRTT, CDMA 1xEVDO, GSM, CDPD, GPRS, EDGE, UMTS, RD-LAP, SMR, LMR) represent examples of the state of the art. Such standards are periodically superseded by faster or more efficient equivalents having essentially the same functions. Accordingly, replacement standards and protocols having the same functions are considered equivalents.

What is claimed:

1. A method for seamlessly roaming across a plurality of dissimilar wireless networks using at least one software defined radio (SDR), the at least one SDR including a plurality of modulation algorithms, each algorithm enabling access to at least one of the dissimilar networks, the method comprising:
seamlessly roaming across the dissimilar wireless networks while only using a single transceiver of the at least one SDR; and
prioritizing the modulation algorithms.

2. The method of claim 1, further comprising scanning for a limited time an alternate network of the plurality of wireless networks, when a primary network of the plurality of networks is designated as in-use.

3. The method of claim 1, further comprising updating the prioritization of modulation algorithms in response to hint criteria being satisfied.

4. The method of claim 3, in which the hint criteria designates a time.

5. The method of claim 3, in which the hint criteria designates a location.

6. The method of claim 1, further comprising scanning the dissimilar networks to check a network quality.

7. The method of claim 1, further comprising scanning the dissimilar networks, the scanning comprising downloading a modulation algorithm to the at least one SDR, initializing the at least one SDR and checking whether a network associated with the downloaded algorithm is in coverage.

8. A system for seamlessly roaming across a plurality of dissimilar wireless networks using at least one software defined radio (SDR), the at least one SDR including a plurality of modulation algorithms, each algorithm enabling access to at least one of the dissimilar networks, the system comprising:
a network management subsystem that processes packets to be sent to a network accessible through a selected modulation algorithm of the at least one SDR, and scans through modulation algorithms on the at least one SDR device; and
a configuration subsystem that communicates with the network management subsystem to provide configuration information.

9. The system of claim 8, further comprising an application programming interface (API) subsystem that receives network status notifications from the network management subsystem and publishes the status notifications for external entities.

10. The system of claim 8, in which the network management subsystem further checks network quality of networks accessible through selected modulation algorithms.

11. The system of claim 8, in which the configuration subsystem communicates with a centralized software controller to obtain configuration updates.

12. The system of claim 9, in which the API subsystem receives instructions from an external entity to designate at least one of the dissimilar networks as currently most preferred.

13. The system of claim 9, in which the API subsystem receives instructions from an external entity to transmit a packet through a specific one of the dissimilar wireless networks.

14. The system of claim 8, further comprising a routing support subsystem that aborts scans to minimize packet loss.

15. A computer readable medium for storing a program for seamlessly roaming across a plurality of dissimilar wireless networks using at least one software defined radio (SDR), the at least one SDR including a plurality of modulation algorithms, each algorithm enabling access to at least one of the dissimilar networks, the medium comprising:
a roaming code segment that enables seamless roaming across the dissimilar wireless networks while only using a single transceiver of the at least one SDR; and
a priority code segment that prioritizes the modulation algorithms.

16. The medium of claim 15, further comprising a scanning code segment that scans for a limited time an alternate network of the plurality of wireless networks, when a primary network of the plurality of networks is designated as in-use.

17. The medium of claim 15, further comprising a hint code segment that updates the modulation algorithm priorities in response to hint criteria being satisfied.

18. The medium of claim 15, further comprising a scanning code segment that scans the dissimilar networks to check a quality of the networks.

19. The medium of claim 15, further comprising a scanning code segment that scans the dissimilar networks by downloading a modulation algorithm to the at least one SDR, initializing the at least one SDR, and checking whether a network associated with the downloaded algorithm is in coverage.

20. The medium of claim 15, further comprising a pruning code segment that ensures that each connected modulation algorithm is used by only a single SDR.

21. The medium of claim 17, further comprising a receiving code segment that receives hint updates from an external entity.

22. The medium of claim 15, further comprising a scan frequency code segment that dynamically changes a scan frequency based upon a state of the at least one SDR.

23. The medium of claim 15, further comprising a coverage checking frequency code segment that changes a coverage checking frequency based upon each modulation algorithm.

24. The medium of claim 15, wherein each modulation algorithm comprises a GPS algorithm or a bi-directional data network modulation algorithm.

25. The medium of claim 15, in which the roaming code segment further enables simultaneous use of multiple networks.
